(19) United States
(12) Patent Application Publication
(10) Pub. No.: US 2016/0162970 A1
(43) Pub. Date: Jun. 9, 2016

(54) System and Method for Matching Consumers with Real Estate Service Providers

(71) Applicant: Tim Ketron, Front Royal, VA (US)

(72) Inventor: Tim Ketron, Front Royal, VA (US)

(21) Appl. No.: 14/958,220

(22) Filed: Dec. 3, 2015

Related U.S. Application Data
(60) Provisional application No. 62/086,750, filed on Dec. 3, 2014.

(51) Int. Cl. G06Q 30/06; G06Q 50/16

(52) U.S. Cl. CPC G06Q 30/0625; G06Q 30/0641; G06Q 50/167

(57) ABSTRACT

A system and method for connecting consumers to real estate service providers. The present method includes the steps of obtaining a real estate action selection from the user, presenting the user with criteria relevant to choosing a service provider that can aid in accomplishing the selected action, obtaining criteria selections from the user, and identifying candidates based on the user's selected criteria. The matching system also provides a feedback tool that allows consumers to rate and comment on the chosen candidate, an educational tool that displays definitions and advisory comments, and a GPS home search tool that notifies a user when he or she is within a pre-selected proximity of a home that meets the user's specifications.

### CROSS REFERENCE TO RELATED APPLICATIONS

This application claims the benefit of U.S. Provisional Application No. 62/086,750 filed on Dec. 3, 2014. The above identified patent application is herein incorporated by reference in its entirety to provide continuity of disclosure.

### BACKGROUND OF THE INVENTION

The present invention relates to real estate services. More specifically, the present invention relates to a system and method for matching users with real estate service providers based on criteria selected by the user.

Purchasing real estate is one of the most costly investments an individual will make. As such, those who do so generally take as many precautionary measures as possible. It can be a long, difficult process for an individual to find real estate agents, other service providers, or properties that meet his or her needs and preferences. In addition, real estate service providers may charge exorbitant fees, some of which the consumer may be unaware. Consumers may also be misled by collusion between competing real estate companies or unfair referral practices. Therefore, there is a need for a neutral system and method that connects consumers to real estate service providers based on consumer-selected criteria.

There are existing systems that connect consumers to real estate service providers. Some of these systems match consumers with real estate agents using a compatibility ranking method. However, the existing compatibility ranking methods use geographic location as a deciding factor of compatibility. Further, the existing systems and methods for providing the consumer with real estate agent referrals are based on criteria that the agent requires of the consumer, such as age, location, gender, ethnicity, pet ownership, etc. However, these systems and methods fail to allow for consumer preferences. In addition, existing systems and methods fail to inform consumers of other service providers they will need in the real estate investment process, such as lenders, title companies, insurance companies, and inspection companies.

Therefore, there is a need in the prior art for a system and method for matching consumers with real estate service providers based on criteria that the consumer selects. There is also a need to educate consumers on the importance of each criteria selection in connection with various real estate practices. Overall, there is a lack of systems and methods available to ensure that consumers are fully informed of real estate related issues thus providing maximum consumer protection and fairness.

### SUMMARY OF THE INVENTION

In view of the foregoing disadvantages inherent in the known types of systems and methods for connecting consumers to real estate service providers now present in the prior art, the present invention provides the user with a criteria-based matching method that connects the user to a real estate service provider that meets the user's needs and preferences while educating the user about real estate practices. The present system comprises a web-based platform that allows real estate service providers to make a profile introducing their businesses. Users select a real estate action that they need to accomplish. Then, users are instructed to make criteria selections based on characteristics they desire in a real estate service provider that would perform this action. The present system is configured to educate consumers regarding real estate processes throughout their use of the system. Specifically, the system explains why each of the actions or criteria is important to real estate practices.

After users enter their criteria selections, the present system provides users with a list of real estate service providers ranked from best to worst based on the number of matching criteria. Once the user has retained the services of the matched provider, the user may rate his or her satisfaction with that provider. The system also allows users to explain ratings through a comment feature. Feedback responses must be verified and approved by the site administrator before they are posted to the public.

In addition, the system provides a GPS home location tool. The user enters housing specifications and a proximity radius. Each time the user's mobile device is within the pre-selected radius of a home for sale that meets the user's specifications, a notification is sent to the user's mobile device.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a flowchart illustrating an embodiment of a method for matching a user to a real estate service provider.

FIG. 2 shows a diagram illustrating one embodiment for an educational tool.

FIG. 3 shows a diagram illustrating one embodiment for a feedback tool.

FIG. 4 shows a diagram illustrating one embodiment for a GPS home location tool.

### DETAILED DESCRIPTION OF THE INVENTION

Reference is made herein to the attached drawings. Like reference numerals are used throughout the drawings to depict like or similar elements of the system and method for matching consumers to real estate services. For the purposes of presenting a brief and clear description of the present invention, the preferred embodiment will be discussed as used for matching consumers to real estate service providers. The figures are intended for representative purposes only and should not be considered to be limiting in any respect.

As used herein, “processor” refers to one or more devices, circuits, and/or cores configured to process data, such as a set of steps according to a computer program. Unless stated otherwise, a component such as a processor or interface described as being configured to perform a task includes both components temporarily configured to perform a task at a specified time and components manufactured to perform a task. As used herein, “logic” refers to (i) logic implemented as computer instructions and/or data within one or more computer processes and/or (ii) logic implemented in electric circuitry. As used herein, “real estate service provider” and “candidate” can be used interchangeably and include, but are not limited to real estate agents, lenders, title companies, insurance companies, and inspection companies. As used herein, “real estate practices” include, but are not limited to, real estate transactions, referral practices, and investment precautions.

The present invention is a system and method for matching consumers to real estate service providers. The types of consumers this system and method are aimed to assist include, but are not limited to home buyers, home sellers, those wishing not to use the assistance of a real estate agent, those seeking to refinance, and those seeking a home equity loan. Further, these consumers are not limited to individuals and can include corporations, partnerships, or other entities. Similarly, consumers this system and method aim to assist also include those looking for real estate service providers dealing in commercial and rental properties. The purpose of the present invention is to force compliance with federal regulations in the real estate industry and ensure complete consumer fairness. This purpose is accomplished with the present system and method by educating the user, providing consumer selected criteria filters, and removing real estate service provider affiliations and kickbacks in the process.

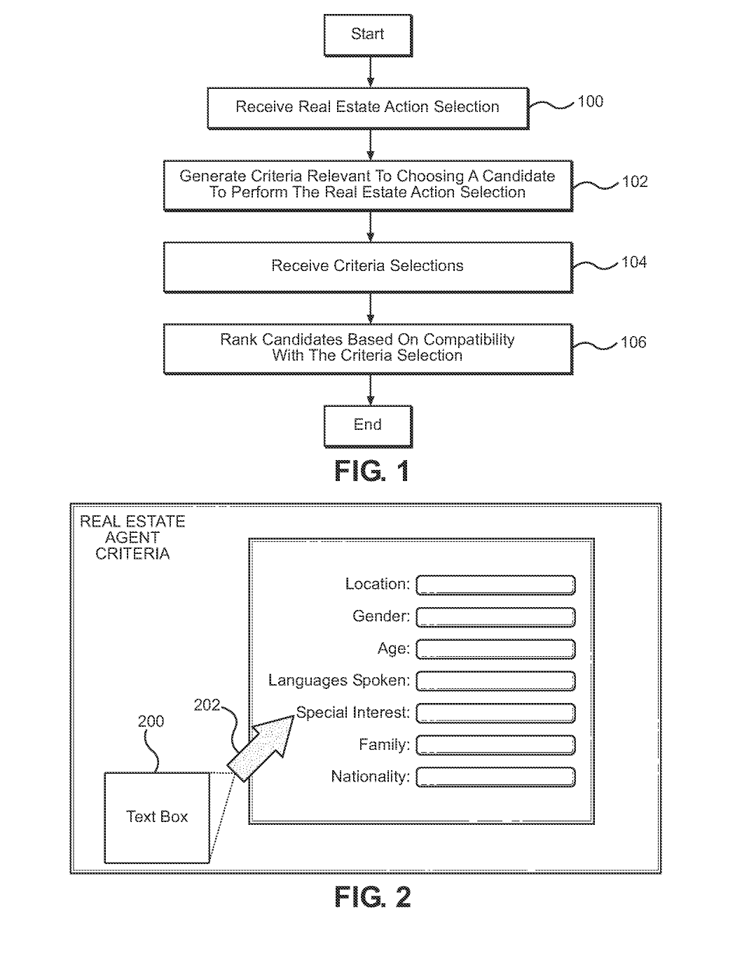

Referring now to FIG. 1, there is shown a flowchart illustrating an embodiment of a method for matching a user to a real estate service provider. At 100, a user is presented with one or more real estate actions and is prompted to select the action that he or she needs. Real estate actions are those provided by real estate agents, lenders, title companies, insurance companies, and inspection companies, for example. Thus, a user may select an action such as: buying a house, obtaining homeowner's insurance, obtaining a mortgage, running a title search, etc.

At 102, criteria is generated that is relevant to choosing a candidate for the real estate action selected by the user. Each real estate action has a set of criteria relevant to choosing a provider that will perform that action stored in a database. The database provides this set of relevant criteria when queried with the real estate action selection by the logic. Therefore, for example, real estate agents, lenders, and title companies will have separate sets of criteria associated with each. However, some of the criteria is relevant to choosing any type of real estate service provider, such as years of experience and use of current technology, and will appear in each set of criteria. The criteria is presented to the user when the user makes the real estate action selection. For example, if the user selects the action of “buying a house,” criteria related to choosing a real estate agent will be generated. This criteria might include gender, marital status, children, special interests, languages spoken, use of technology, etc.

In another example, if the user selects the action of “obtaining a mortgage” or “obtaining a loan,” criteria related to choosing a lender will be generated. This criteria might include the type of company, attendance at closings, types of loan programs offered, types of specialty loans offered, etc. Additionally, a user could select an action such as “title search” or “get title insurance,” and criteria related to choosing a title company will be generated. Criteria for choosing a title company might include whether the company has a national or local presence, whether it offers short sale negotiations, if it has worked with 203K closings, and the average turnaround time.

At 104, criteria selections are obtained from a user. These criteria selections are based on the user's needs and preferences. For example, a user will need a real estate agent that speaks the same language as the user. A user might also prefer lenders that offer specific types of loan programs or specialty loans. Some users may need a provider that is available at early or late hours and can accommodate the user's schedule.

At 106, the criteria selections are used to rank candidates in order to generate matches that meet the user's needs and preferences. In one embodiment, the candidates are ranked from best to worst according to the number of criteria the candidate has that matches the user's selections. The criteria selections are used to filter out candidates that do not meet at least one of the user's criteria selections.

Referring now to FIG. 2, there is shown a diagram illustrating one embodiment for an educational tool. This tool displaying education information is incorporated at every step in the process and its purpose is to inform users of real estate definitions and practices. In the depicted embodiment, the educational tool functions as a hover-over display 200. In this embodiment, the hover-over display 200 is shown when the user hovers a mouse arrow 202 over a criteria. The content of the display 200 is designed to provide advisory comments, definitions, and explanations of real estate practices. For example, if the user was choosing a real estate agent and hovered over the criteria labeled “gender,” a display 200 will appear that explains that the gender of the real estate agent could be important because the user might spend a lot of time viewing houses alone with the real estate agent.

Although the depicted embodiment shows a display 200 based on the criteria for selecting a real estate agent, a display 200 may also appear when the user hovers a mouse arrow 202 over any other part of the system. For example, when the user is selecting a real estate action, such as “title search,” a display may appear that describes that a title search is important to determine legal interests and regulations encumbering a piece of property. In various embodiments, the educational tool functions as a pop-up display when the user interacts with the system. A pop-up display would have the same information as the hover-over embodiment, but would not appear until the user clicked or otherwise selected an action or criteria.

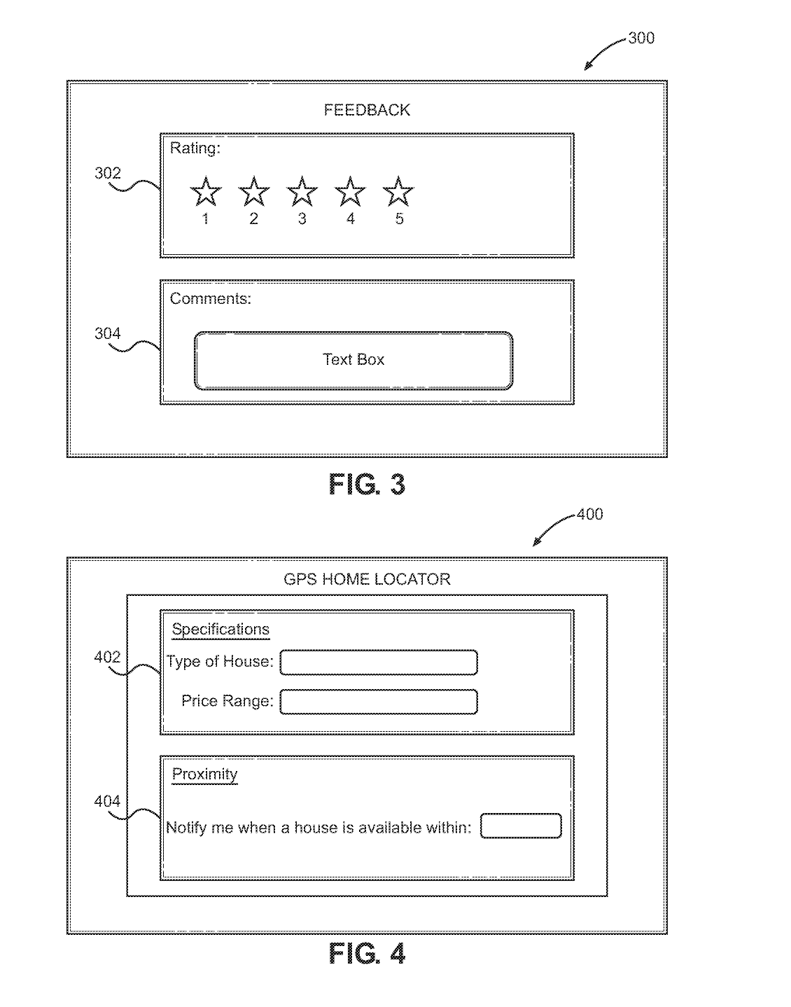

Referring now to FIG. 3, there is shown a diagram illustrating one embodiment for a feedback tool. In the depicted embodiment, the feedback tool 300 includes a rating feature 302 where the user can rate the service provided by a chosen candidate. For example, the user can rate the service provided by a chosen candidate by making a selection on a numbered scale. Also in this embodiment, the feedback tool 300 includes a comment feature 304 where the user can type a comment explaining the rating or give details about the services rendered. In various embodiments, information received through the feedback tool must be approved by a system administrator before it is made available to the public. The purpose of this approval process is to limit publication to only those comments that are a fair and an honest reflection of the services rendered. Allowing users to submit feedback based on service satisfaction can aid in preventing collusion between competitive companies and eliminating unfair referral practices.

Referring now to FIG. 4, there is shown a diagram illustrating one embodiment for the GPS home location tool. The purpose of the GPS home location tool 400 is to notify users when a house they would be interested in purchasing is nearby. This will allow users to expand their property search and view homes that are conveniently located nearby. In the depicted embodiment, there are fillable specifications 402 where users can enter in characteristics of the home they are looking for. For example, this might include the type of house and the price range. This embodiment also includes a proximity selection 404, where the user can enter the distance the GPS locator will search for homes meeting the user's specifications. Once entered, the logic will query a database to determine if the user is within the selected proximity of a home meeting his or her specifications, the GPS home location tool will send a notification to the logic.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A real estate matching service method, comprising the steps of:
receiving a real estate action selection;
querying a database for criteria relevant to choosing a candidate for the real estate action selected;
retrieving criteria relevant to choosing a candidate for the real estate action selected;
displaying educational information;
receiving a criteria selection;
ranking the candidate based on compatibility with the criteria selection; and
receiving a rating for the candidate.

2) The method of claim 1, wherein the educational information is a real estate definition.

3) The method of claim 1, wherein the educational information is an explanation of a real estate practice.

4) The method of claim 1, wherein the rating is a selection on a numbered scale.

5) The method of claim 1, wherein the rating is a comment describing a service rendered by the candidate.

6) A non-transitory computer-readable medium storing a logic for matching a user to a real estate service provider that, when executed by a processor of a computer, causes the computer to perform a method comprising the steps of:
receiving a real estate action selection;
querying a database for criteria relevant to choosing a candidate for the real estate action selected;
retrieving criteria relevant to choosing a candidate for the real estate action selected;
displaying educational information;
receiving a criteria selection;
ranking the candidate based on compatibility with the criteria selection; and
receiving a rating for the candidate.

7) The method of claim 6, wherein the educational information is a real estate definition.

8) The method of claim 6, wherein the educational information is an explanation of a real estate practice.

9) The method of claim 6, wherein the rating is a selection on a numbered scale.

10) The method of claim 6, wherein the rating is a comment describing a service rendered by the candidate.

11) The method of claim 6, further comprising the step of receiving a proximity selection wherein the proximity selection is a distance from a user that the logic will query a database for homes within the distance.

12) The method of claim 6, further comprising the step of receiving a house type characteristic wherein the logic queries a database for homes having the house type characteristic.

13) The method of claim 6, further comprising the step of receiving a price range characteristic wherein the logic queries a database for homes having the price range characteristic.

14) A computer device with memory stored instructions which, when executed by a processor, causes the processor to perform the method comprising the steps of:
receiving a real estate action selection;
querying a database for criteria relevant to choosing a candidate for the real estate action selected;
retrieving criteria relevant to choosing a candidate for the real estate action selected;
displaying educational information;
receiving a criteria selection;
ranking the candidate based on compatibility with the criteria selection; and
receiving a rating for the candidate.

15) The method of claim 14, wherein the educational information is a real estate definition.

16) The method of claim 14, wherein the educational information is an explanation of a real estate practice.

17) The method of claim 14, wherein the rating is a selection on a numbered scale.

18) The method of claim 14, wherein the rating is a comment describing a service rendered by the candidate.

19) The method of claim 14, further comprising the step of receiving a proximity selection wherein the proximity selection is a distance from a user that the logic will query a database for homes within the distance.

20) The method of claim 14, further comprising the step of receiving a house type characteristic wherein the logic queries a database for homes having the house type characteristic.

21) The method of claim 14, further comprising the step of receiving a price range characteristic wherein the logic queries a database for homes having the price range characteristic.
